(19) United States
(12) Patent Application Publication
(10) Pub. No.: US 2016/0021035 A1
(43) Pub. Date: Jan. 21, 2016

(54) CREATING A USER GROUP

(71) Applicant: Alibaba Group Holding Limited, Grand Cayman (KY)

(72) Inventor: Jingjing Shen, Hangzhou (CN)

(21) Appl. No.: 14/798,301

(22) Filed: Jul. 13, 2015

(30) Foreign Application Priority Data
Jul. 15, 2014 (CN) 201410336495.5

(51) Int. Cl. H04L 12/58; H04L 29/08

(52) U.S. Cl. CPC H04L 51/04; H04L 67/1044

(57) ABSTRACT

Group creation information sent by multiple instant messaging client terminals are received, wherein the group creation information includes instruction information for creating a user group and an instant messaging identification of a user logging into a respective instant messaging client terminal. Group creation information set including the same instruction information is determined. The user group is created according to the instant messaging identification included in the group creation information set. When an instant messaging server determines that parts of the multiple pieces of the received group creation information request to establish the same user group, the instant messaging server, by using the instruction information in the group creation information, quickly determines which pieces of the group creation information instruct to establish the same user group and creates the user group, thereby effectively reducing the time of gathering group members and enhancing the efficiency of creating a user group platform.

### CROSS-REFERENCE TO RELATED PATENT APPLICATION

This application claims foreign priority to Chinese Patent Application No. 201410336495.5 filed on 15 Jul. 2014, entitled “Method and Apparatus for Creating A User Group,” which is hereby incorporated by reference in its entirety.

### TECHNICAL FIELD

The present disclosure relates to the field of Internet information processing technology, and, more particularly, to a method and device for creating a user group.

### BACKGROUND

With the development of communication technologies, instant messaging (IM) as a terminal service has brought a huge convenience to communication among people. The so-called IM allows two or more users to transmit text data, voice data, and video data instantly by using a network, thereby implementing an instant communication among two or more users. Common instant messaging software includes Tencent™ QQ™ instant messaging software, Wechat™, Skype™, Ali-wangwang, and so on.

In order to implement a communication among users at the same time through instant messaging, a mode of establishing a user group by using the instant messaging is provided. The so-called user group, namely a collection of users, includes more than one user with the attributes that multiple users belonging to the same user group are capable of communicating simultaneously and each user in the user group releases data in the user group, which is viewed by other users in the user group. Therefore, a creation of the user group facilitates the communication among people, especially, the communication among members of the group or the communication among schoolmates to achieve the purpose of information sharing.

However, at present, the user group in the instant messaging is created in the following mode:

A first step: the user initiates a creation of a user group and acquires a group identification of the user group, wherein the user who creates the user group is called a group leader user.

A second step: the group leader user who initiates the creation of the user group adds group users in the user group manually.

Specifically, when the group leader user adds the group users in the user group manually, if the group leader user and the to-be-added group users are not friends, the group leader user needs to add the to-be-added group users as friends firstly, and then the group leader user adds manually the group users as group members of the created user group.

In the conventional techniques for establishing the user group, when the group leader user applies for establishing the user group and acquires an identification of the user group, an instant messaging server allocates resources for the user group on the server according to the identification of the user group and then the group leader user actively adds other users who are already friends in the created user group. However, when other users who are not the group leader user's friends want to join in the user group, they join the user group only after that the group leader user adds those who are not the group leader user's friends as friends or after passing the verification of the group leader user. Thus, at present, upon the application of the identification of the user group, a user group is created at the instant messaging server, but it is a complicated process to add a large number of group users in the user group, which complicates the process of generating the user group, prolongs the time for collecting the group users in the user group, and results in an inefficient creation of the user group.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

In view of the above, the example embodiments of the present disclosure provide an example method and device for creating a user group to solve a problem in the conventional techniques with an inefficient creation of the user group.

The present disclosure provides an example method for creating a user group, which may include the following operations:

Multiple group creation information sent by at least two instant messaging client terminals are received respectively, wherein a respective piece of group creation information includes instruction information for creating a user group and a respective instant messaging identification of a respective user logging into a respective instant messaging client terminal.

According to the instruction information for creating a user group included in the group creation information, group creation information set including the same instruction information is determined.

The user group is created according to the instant messaging identifications included in each of the group creation information in the group creation information set.

A group identification of the user group is determined and a corresponding relationship between the instant messaging identification included in the user group and the group identification of the user group is established.

The group identification of the user group is determined according to the instruction information included in the group creation information set.

The method may further include the following operations.

A group creation acknowledgment notification is created, wherein the group creation acknowledgment notification carries the instant messaging identifications included in the group creation information in the group creation information set.

The group creation acknowledgment notification is sent to each instant messaging client terminal to which the respective user corresponding to the respective instant messaging identification logs in according to the instant messaging identification carried in the group creation acknowledgment notification.

The method may further include the following operations.

An instant messaging identification included in the group creation information is selected from the group creation information set as a group leader instant messaging identification of the to-be-created user group corresponding to the group creation information set.

The operation for creating the user group may include the following operations.

Group creation feedback information sent by the instant messaging client terminal corresponding to the group leader instant messaging identification is received, wherein the group creation feedback information includes the instant messaging identifications of other users allowed to join the same group as determined by the group leader user corresponding to the group leader instant messaging identification.

A corresponding relationship between the instant messaging identifications of other users included in the group creation feedback information and the group identification of the user group is established according to the instant messaging identifications of other users included in the group creation feedback information.

For example, the group creation information sent by the group creation initiator through the instant messaging client terminal includes group leader information.

The operation for selecting an instant messaging identification included in the group creation information from the group creation information set as a group leader instant messaging identification of the to-be-created user group corresponding to the group creation information set may include the following operations.

Whether the group creation information in the group creation information set includes the group leader information is determined. If the group creation information in the group creation information set includes the group leader information, the instant messaging identification included in the group creation information is used as the group leader instant messaging identification of the to-be-created user group corresponding to the group creation information set.

For example, the respective piece of group creation information or instruction information may include or be associated with location information of a user.

The operation for determining the group creation information set including the same instruction information may include the following operations.

Whether a difference between the location information included in each piece of the received group creation information and a set location information threshold is less than a set threshold is determined. The multiple pieces of group creation information with a determining result that the difference between the location information included in the group creation information and the set location information threshold is less than the set threshold are determined as the group creation information set including the same instruction information.

For example, the group creation information sent by the group creation initiator through the instant messaging client terminal may include or be associated with an effective time for sending the group creation information;

The operation for creating the user group may further include the following operations.

Whether the time for each piece of group creation information in the group creation information set conforms to the effective time for sending the group creation information included in the group creation information sent by the group leader is determined. With respect to the group creation information with the determining result as conforming in the group creation information set, the user group is created, wherein the user group includes the instant messaging identification of the user included in the group creation information with the determining result as conformed.

The present disclosure also provides an example device for creating a user group, which may include the following modules:
a receiving module that receives multiple group creation information sent by at least two instant messaging client terminals, wherein each piece of group creation information includes instruction information for creating a user group and a respective instant messaging identification of a respective user logging into the respective instant messaging client terminal; and
a group creating module that determines a group creation information set including the same instruction information according to the instruction information for creating a user group included in the group creation information; and creates the user group according to the instant messaging identification included in the group creation information in the group creation information set; and determines a group identification of the user group, and establishes a corresponding relationship between the instant messaging identification included in the user group and the group identification of the user group.

The group identification of the user group is determined according to the instruction information included in the group creation information set.

The device may further include the following modules including:
an acknowledgment information generating module that generates a group creation acknowledgment notification, wherein the group creation acknowledgment notification carries the instant messaging identification included in the group creation information in the group creation information set; and
an acknowledgment information sending module that sends the group creation acknowledgment notification to each instant messaging client terminal to which a user corresponding to the instant messaging identification logs in according to the instant messaging identification carried in the group creation acknowledgment notification.

The device may further include the following modules including:
a group leader identification determining module that selects an instant messaging identification included in a piece of group creation information from the group creation information set as a group leader instant messaging identification of the to-be-created user group corresponding to the group creation information set.

The group creating module further receives group creation feedback information sent by the instant messaging client terminal corresponding to the group leader instant messaging identification, wherein the group creation feedback information includes the instant messaging identifications of other users allowed to join the same group as determined by the group leader user corresponding to the group leader instant messaging identification; and establishes a corresponding relationship between the instant messaging identifications of other users included in the group creation feedback information and the group identification of the user group according to the instant messaging identification of other users included in the group creation feedback information.

For example, the group creation information sent by the group creation initiator through the instant messaging client terminal may include group leader information.

The group leader identification determining module further determines whether the group creation information in the group creation information set includes the group leader information; and if a piece of group creation information in the group creation information set includes the group leader information, uses the instant messaging identification included in the group creation information as the group leader instant messaging identification of the to-be-created user group corresponding to the group creation information set.

For example, the respective group creation information or instruction information may include or be associated with respective location information of a respective user.

The group creating module may further determine whether a difference between the location information included in each piece of the received group creation information and a set location information threshold is less than a set threshold; and use the multiple pieces of group creation information with a determining result that the difference between the location information included in the group creation information and the set location information threshold is less than a set threshold as the group creation information set including the same instruction information.

For example, the group creation information sent by the group creation initiator through the instant messaging client terminal may include or be associated with an effective time for sending the group creation information.

The group creating module may further determine whether the time for each piece of group creation information in the group creation information set conforms to the effective time for sending the group creation information included in the group creation information sent by the group leader; and, with respect to the group creation information with the determining result as conforming in the group creation information set, create the user group, wherein the user group includes the instant messaging identification of the user included in the group creation information with the determining result as being conforming.

The present disclosure has at least the following technical advantages. The example embodiments of the present disclosure include receiving group creation information sent by at least two instant messaging client terminals, wherein each piece of the group creation information includes a piece of instruction information for creating a user group and instant messaging identification information of the user logging into the instant messaging client terminal; determining a group creation information set including the same instruction information according to the instruction information for creating a user group included in the group creation information; creating the user group according to the instant messaging identification included in the group creation information in the group creation information set; and determining a group identification of the user group, and establishing a corresponding relationship between the instant messaging identification included in the user group and the group identification of the user group. Thus, when the instant messaging server receives multiple pieces of group creation information in the same period of time, wherein part of the multiple pieces of the received group creation information needs to establish the same group, the instant messaging server, by using the instruction information in the group creation information, may determine quickly which pieces of the group creation information instruct to establish the same group and create the user group, which effectively reduces the time of gathering group members and enhances the efficiency of creating a user group platform.

### BRIEF DESCRIPTION OF THE DRAWINGS

To clearly describe the technical solutions in the example embodiments of the present disclosure, the following briefly introduces the accompanying drawings needed for describing the example embodiments. Apparently, the accompanying drawings in the following description are merely a part of the embodiments of the present disclosure. A person of ordinary skill in the art may acquire other drawings from these accompanying drawings without using creative efforts.

FIG. 1 is a flow chart of an example method for creating a user group according to the present disclosure; and

FIG. 2 is a structural diagram of an example device for creating a user group according to the present disclosure.

### DETAILED DESCRIPTION

In order to achieve the purpose of the present disclosure, the example embodiments of the present disclosure provide a method and device for creating a user group. The techniques of the present disclosure include: receiving group creation information sent by at least two instant messaging client terminals, wherein each piece of the group creation information includes a piece of instruction information for creating a user group and instant messaging identification information of the user logging into the instant messaging client terminal; determining a group creation information set including the same instruction information according to the instruction information for creating a user group included in the group creation information; creating the user group according to the instant messaging identification included in the group creation information in the group creation information set; and determining a group identification of the user group, and establishing a corresponding relationship between the instant messaging identification(s) included in the user group and the group identification of the user group. Thus, when the instant messaging server receives multiple pieces of group creation information in the same period of time, wherein part of the multiple pieces of the received group creation information needs to establish the same group, the instant messaging server, by using the instruction information in the group creation information, may determine quickly which pieces of the group creation information instruct to establish the same group and create the user group, which effectively reduces the time of gathering group members and enhances the efficiency of creating a user group platform.

The present disclosure is further clearly described as follows with reference to the accompanying drawings of the specification. Apparently, the example embodiments described herein are merely a part of, and not all of, the embodiments of the present disclosure. All other embodiments acquired by persons of ordinary skill in the art based on the example embodiments of the present disclosure without using creative efforts shall belong to the protection scope of the present disclosure.

A first example embodiment of the present disclosure is described below.

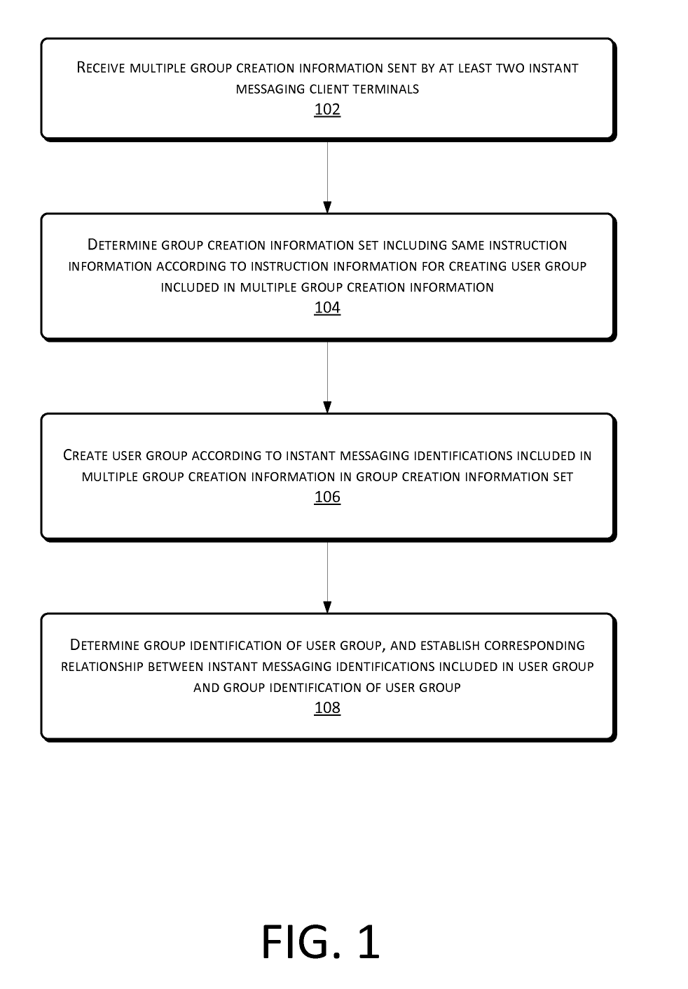

FIG. 1 illustrates a flow chart of an example method for creating a user group according to the first embodiment of the present disclosure. The method may include the following operations.

At 102, an instant messaging server receives multiple group creation information sent by at least two instant messaging client terminals respectively.

Each of the group creation information includes a piece of instruction information for creating a user group and respective instant messaging identification information of a respective user logging into a respective instant messaging client terminal.

The instant messaging client terminal includes an instant messaging program installed at a terminal device of the user.

At 102, in order to meet the demand of work or study and facilitate the communication or study among multiple users including group users or participants, a user group needs to be created, and a user group communication platform in the instant messaging is used for communication.

In the present disclosure, for example, when it is determined that the user group needs to be created, the method may further include the following operations.

As an initiator for creating the user group, a first user uses an instant messaging client terminal, to which the first user logs in, to initiate a request for creating a group to other instant messaging client terminals, to which other users in the to-be-created user group log in, and inform other users that the user group needs to be created.

Specifically, the method for the instant messaging client terminal, to which the first user logs in, to initiate a request for creating a group to the instant messaging client terminals, to which other users in the to-be-created user group log in, may include, but is not limited to, the following operations.

The request for creating a group is sent to other instant messaging client terminals, to which other users in the to-be-created user group log in, by other modes (such as an e-mail, a message announcement, a wireless communication, or the like), wherein the request for creating a group includes instruction information for creating a user group.

For example, the instruction information for creating a group may be a piece of text information, or a creation instruction which needs other users to report the current location information, etc. The present disclosure does not impose any restriction herein.

If the instruction information for creating a user group is an identification information, for example, a character string (such as XXhuiyi2014), a two-dimensional code (such as QR code), and the like, the instant messaging client terminal of the first user, when sending the request for creating a group in other modes, will carry the identification information for creating the user group in the request for creating a group and send it to other users.

For example, the first user is a conference organizer, and then the participants who attend this conference will be the target user of the user group created by the first user for the conference.

The instant messaging client terminal corresponding to the first user receives an indication from the first user that determines a piece of instruction information (for example, a character string) for the user group created for the conference, and sends a request for creating a group to the instant messaging client terminals of participants in other modes and carries the determined instruction information for the user group for the conference in the request for creating a group. In this way, when the instant messaging client terminals of the participants send their group creation information to the instant messaging server, as long as the instruction information is caned in the group creation information, the instant messaging server identifies the target user of the user group for the conference.

If the instruction information for creating a user group is a creation instruction (for example, an instruction information which requires other users to locate the current location information and report the group creation information carried in the location information to the instant messaging server), at the instant messaging client terminal corresponding to the first user, when the request for creating a group is sent in other modes, the creation instruction for creating the user group is carried in the request for creating a group and is sent to other users.

For example, the first user is a conference organizer, and the participants who attend this conference will be the target user of the user group created by the first user for the conference.

The first user determines a piece of instruction information (for example, a creation instruction, which is an instruction which requires other users to locate the current location information and report the group creation information carried in the location information to the instant messaging server) for the user group created for the conference, which is received by the instant messaging client terminal corresponding to the first user.

The instant messaging client terminal corresponding to the first user sends a request for creating a group to the instant messaging client terminals of the participants in other modes, and carries the determined instruction for creating the user group for the conference in the request for creating a group. In this way, the instant messaging client terminals of the participants determine the current location information (the mode may be, but is not limited to, that the instant messaging client terminal determines its location information when a participant uses “shake it off” function in some instant messaging program to request the current location information, which is not limited herein) according to the received creation instruction, and send the group creation information carried in the determined current location information to the instant messaging server upon receiving an indication from the participants. The instant messaging server identifies the target user of the user group for the conference according to the location information included in the received group creation information.

Optionally, the request for creating a group further includes an effective time for sending the group creation information.

The effective time is used to limit the time for other users to send the group creation information through the instant messaging client terminal, so that the group creation information sent during the effective time will be valid, which avoids the prolonging of the time for processing the group creation information, effectively reduces the time for gathering the users in the user group, and enhances the efficiency of establishing the user group platform.

In other words, once the effective time is due, the sent group creation information will be regarded as invalid group creation information, so that other users who send such invalid group creation information will miss the opportunity for applying for the to-be-created user group.

For example, the effective time may be a time length, or a time point, and may also be a time period, which may be set according to the actual needs or experiment data and is not limited herein.

The users who receive the request for creating a group, when determining that they are the target users of the to-be-created user group, send the group creation information to the instant messaging server.

Each piece of the group creation information includes the instruction information for creating a user group and an instant messaging identification logging into a respective instant messaging client terminal.

In addition, each piece of group creation information may further include an effective time for sending the group creation information.

For example, the instant messaging client terminal of the first user as the initiator of the user group when sending the group creation information to the instant messaging server, may need to include the group leader information in the group creation information. Thus, the instant messaging server identifies a group leader of the to-be-created user group.

In another example embodiment of the present disclosure, the method may further include the following operations.

Time information of the receipt of each piece of group creation information is determined.

In addition, if each piece of the received group creation information includes an effective time for sending the group creation information, whether the received group creation information is valid will be determined by comparing the determined time information with the effective time for sending the group creation information, and a subsequent operation will be performed for the valid group creation information. With respect to the invalid group creation information, no subsequent operation will be performed, such that the system resource for processing the group creation information is saved and the system performance is improved.

It should be noted that, the implementation sequence of the operations of the above methods may be as that described in the example embodiment of the present disclosure, or be determined according to the actual needs, such as implementation in other subsequent steps.

At 104, the instant messaging server determines a group creation information set including the same instruction information according to a piece of instruction information for creating a user group included in the multiple group creation information.

At 104, since the instruction information for creating a user group at 102 may be divided into static information and dynamic information, there are at least two methods for determining the group creation information set including the same instruction information as follows:

A first method assumes that the instruction information for creating a group includes static information, such as a string, a two-dimensional code, etc. Instruction information for creating the user group included in the received multiple group creation information is extracted. At least two pieces of group creation information including the same instruction information for creating a user group are regarded as a group creation information set including the same instruction information.

A second method assumes that the instruction information for creating a group includes dynamic information, such as, reporting the location information of the user. The group creation information set including the same instruction information is determined as follows.

Whether a difference between the location information included in each piece of the received group creation information and a set location information threshold is less than a set threshold is determined. The multiple pieces of group creation information with a determining result that the difference between the location information included in the group creation information and the set location information threshold is less than the set threshold are regarded as the group creation information set including the same instruction information.

For example, the location information included in the multiple pieces of the received group creation information is extracted. A difference between each piece of location information and the set location information threshold is calculated. The multiple pieces of group creation information corresponding to the calculated difference that is less than the set threshold are used as a group creation information set including the same instruction information.

For instance, the set location information threshold is the location information of the group leader who initiates the creation of the user group, and the set threshold may be the maximum distance value from the location information of the group leader.

That is, users around the group leader in a certain range will be brought into the user group, which facilitates a quick establishment of a communication platform for the users in a classmate gathering or meeting.

At 106, the instant messaging server creates a user group according to the instant messaging identification included in the multiple group creation information in the group creation information set.

At 106, the method may further include the following operations.

A group creation acknowledgment notification is generated, wherein the group creation acknowledgment notification carries the instant messaging identification included in the group creation information in the group creation information set. The group creation acknowledgment notification is sent to each instant messaging client terminal, to which the respective user corresponding to the respective instant messaging identification logs in, according to the instant messaging identification carried in the group creation acknowledgment notification.

In this way, when the instant messaging server determines to create the user group, the respective instant messaging identification that may be included in the user group is sent to the respective messaging client terminal, to which the respective user corresponding to the respective instant messaging identification in the user group logs in, such that each user re-acknowledges whether to participate in the user group, which prevents some users from participating in the user group unintentionally and improves the accuracy of the user information in the user group.

For example, the time for generating and sending the group creation acknowledgment notification is not limited to before the creation of the user group, and it may be during the creation of the user group, or after the creation of the user group, which is not limited herein.

Optionally, the method may further include the following operations.

An instant messaging identification included in the group creation information from the group creation information set is selected as a group leader instant messaging identification of the to-be-created user group corresponding to the group creation information set.

For example, a user group generally includes a group leader user who has a higher operation authority in the user group than the other users in the user group, which facilitates the management of the user group.

Optionally, the group creation information sent by the group creation initiator through the instant messaging client terminal includes group leader information.

For example, the selecting an instant messaging identification included in the group creation information from the group creation information set as a group leader instant messaging identification of the to-be-created user group corresponding to the group creation information set may include the following operations.

Whether the group creation information in the group creation information set includes the group leader information is determined. If a piece of group creation information in the group creation information set includes the group leader information, the corresponding instant messaging identification included in the group creation information is used as the group leader instant messaging identification of the to-be-created user group corresponding to the group creation information set.

That is, after the group creation acknowledgment notification is sent, group creation feedback information sent by the instant messaging client terminal corresponding to the group leader instant messaging identification is received.

The group creation feedback information includes the instant messaging identifications of other users allowed to join the same group as determined by the group leader user corresponding to the group leader instant messaging identification.

A corresponding relationship is established between the instant messaging identifications of other users included in the group creation feedback information and the group identification of the user group according to the instant messaging identifications of other users included in the group creation feedback information.

In this way, when the instant messaging server creates the user group automatically, the instant messaging identifications of the target users are sent to the group leader, and some users who do not belong to the user group may be screened through the group leader, which ensures the security of communication among the user groups in the future.

Optionally, the group creation information sent by the group creation initiator through the instant messaging client terminal includes an effective time for sending the group creation information.

Whether the time for each piece of group creation information in the group creation information set conforms to the effective time for sending the group creation information included in the group creation information sent by a group leader is determined. With respect to the group creation information with the determining result as conforming in the group creation information set, the user group is created, wherein the user group includes the instant messaging identifications of the users included in the group creation information with the determining result as conforming.

In this way, the time length for creating the user group is reduced, and the network resource can be saved.

At 108, the instant messaging server determines a group identification of the user group, and establishes a corresponding relationship between the instant messaging identification included in the user group and the group identification of the user group.

At 108, the instant messaging server creates a user group for a group creation information set, and determines a group identification for the user group. The group identification is generated for the user group by the instant messaging server, and is a unique identification to distinguish such user group from other groups.

For example, the instant messaging server, when determining the group identification of the user group, may determine according to the instruction information included in the group creation information set or according to its own group identification generation rule, which is not limited herein.

Meanwhile, a corresponding relationship between the instant messaging identification included in the user group and the group identification of the user group is established to, upon the receipt of a group message sent by a user using instant messaging software, quickly push the group message to other users in the user group, which realizes a group communication among multiple users in the user group.

According to the solution of the first example embodiment of the present disclosure, the group creation information sent by the at least two instant messaging client terminals is received respectively, wherein each piece of the group creation information includes a piece of instruction information for creating a user group and the instant messaging identification information of the user logging into the instant messaging client terminal. A group creation information set including the same instruction information is determined according to the instruction information for creating a user group included in the group creation information. The user group is created according to the instant messaging identification included in the group creation information in the group creation information set. A group identification of the user group is determined, and a corresponding relationship between the instant messaging identification included in the user group and the group identification of the user group is established. Thus, when the instant messaging server receives multiple pieces of group creation information in the same period of time, wherein part of the multiple pieces of the received group creation information requests to establish the same group, the instant messaging server, by using the instruction information in the group creation information, quickly determines which pieces of the group creation information instruct to establish the same group, and creates the user group, which effectively reduces the time of gathering group members, and enhances the efficiency of creating a user group platform.

A second example embodiment of the present disclosure is described below. The second example embodiment of the present disclosure provides an example method for creating a user group, and the second example embodiment of the present disclosure provides a detailed description of the operations in the first example embodiment of the present disclosure.

Assume that there are 10 users, namely User 1, User 2, User 3, User 4, User 5, User 6, User 7, User 8, User 9, and User 10, who are members of a seminar, wherein a founder of the seminar is User 1.

In order to provide a convenient communication platform for the participating members, User 1 needs to create a user group for the seminar. The instant messaging client terminal to which User 1 has logged in determines a piece of instruction information such as upon receiving instruction from User 1, and sends, through a request for creating a group, the instruction information to the instant messaging client terminal to which User 2 logs in, the instant messaging client terminal to which User 3 logs in, the instant messaging client terminal to which User 4 logs in, the instant messaging client terminal to which User 5 logs in, the instant messaging client terminal to which User 6 logs in, the instant messaging client terminal to which User 7 logs in, the instant messaging client terminal to which User 8 logs in, the instant messaging client terminal to which User 9 logs in, and the instant messaging client terminal to which User 10 logs in.

At this point, the instant messaging client terminal to which User 1 logs in, the instant messaging client terminal to which User 2 logs in, the instant messaging client terminal to which User 3 logs in, the instant messaging client terminal to which User 4 logs in, the instant messaging client terminal to which User 5 logs in, the instant messaging client terminal to which User 6 logs in, the instant messaging client terminal to which User 7 logs in, the instant messaging client terminal to which User 8 logs in, the instant messaging client terminal to which User 9 logs in, and the instant messaging client terminal to which User 10 logs in respectively send group creation information to the instant messaging server, and each piece of group creation information includes the instruction information and a corresponding instant messaging identification.

The instant messaging server, upon the receipt of the group creation information, determines a group creation information set including the same instruction information according to the instruction information included in the group creation information. That is, the group creation information set includes the group creation information sent by the instant messaging client terminal to which User 1 logs in, the group creation information sent by the instant messaging client terminal to which User 2 logs in, the group creation information sent by the instant messaging client terminal to which User 3 logs in, the group creation information sent by the instant messaging client terminal to which User 4 logs in, the group creation information sent by the instant messaging client terminal to which User 5 logs in, the group creation information sent by the instant messaging client terminal to which User 6 logs in, the group creation information sent by the instant messaging client terminal to which User 7 logs in, the group creation information sent by the instant messaging client terminal to which User 8 logs in, the group creation information sent by the instant messaging client terminal to which User 9 logs in, and the group creation information sent by the instant messaging client terminal to which User 10 logs in.

At this point, the instant messaging server creates a user group including an instant messaging identification of User 1, an instant messaging identification of User 2, an instant messaging identification of User 3, an instant messaging identification of User 4, an instant messaging identification of User 5, an instant messaging identification of User 6, an instant messaging identification of User 7, an instant messaging identification of User 8, an instant messaging identification of User 9, and an instant messaging identification of User 10.

Optionally, the instant messaging server, upon the receipt of the group creation information, determines a group leader of the user group, and sends the instant messaging identification carried in other received group creation information to the instant messaging client terminal of the determined group leader, and requests the group leader to acknowledge the instant messaging identifications of other users allowed to join the same user group.

Assuming that the group leader (User 1) acknowledges the instant messaging identifications of other users allowed to join the same user group, e.g., the instant messaging identification of User 2, the instant messaging identification of User 3, the instant messaging identification of User 4, the instant messaging identification of User 5, the instant messaging identification of User 8, and the instant messaging identification of User 9, through its corresponding instant messaging client terminal. Then the instant messaging server creates a user group including the instant messaging identification of User 1, the instant messaging identification of User 2, the instant messaging identification of User 3, the instant messaging identification of User 4, the instant messaging identification of User 5, the instant messaging identification of User 8, and the instant messaging identification of User 9.

Optionally, the effective time for sending the group creation information, which is included the group creation information sent by the instant messaging client terminal to which User 1 logs in, may be 5 minutes, which means that, from the time of the receipt of the group creation information by the instant messaging server from User 1, the group creation information received in 5 minutes is valid, and those received after 5 minutes are invalid.

The group creation information sent by the instant messaging client terminal to which User 2 logs in, upon an instruction from User 2, is received and it is determined that the time of receiving the group creation information is 2 minutes.

The group creation information sent by the instant messaging client terminal to which User 3 logs in, upon an instruction from User 3, is received and it is determined that the time of receiving the group creation information is 2 minutes.

The group creation information sent by the instant messaging client terminal to which User 4 logs in, upon an instruction from User 4, is received and it is determined that the time of receiving the group creation information is 2.5 minutes.

The group creation information sent by the instant messaging client terminal to which User 5 logs in, upon an instruction from User 5, is received and it is determined that the time of receiving the group creation information is 2.5 minutes.

The group creation information sent by the instant messaging client terminal to which User 6 logs in, upon an instruction from User 6, is received and it is determined that the time of receiving the group creation information is 3 minutes.

The group creation information sent by the instant messaging client terminal to which User 7 logs in, upon an instruction from User 7, is received and it is determined that the time of receiving the group creation information is 3.5 minutes.

The group creation information sent by the instant messaging client terminal to which User 8 logs in, upon an instruction from User 8, is received and it is determined that the time of receiving the group creation information is 4 minutes.

The group creation information sent by the instant messaging client terminal to which User 9 logs in, upon an instruction from User 9, is received and it is determined that the time of receiving the group creation information is 6 minutes.

The group creation information sent by the instant messaging client terminal to which User 10 logs in, upon an instruction from User 10, is received and it is determined that the time of receiving the group creation information is 7 minutes.

The instant messaging server creates a user group including the instant messaging identification of User 1, the instant messaging identification of User 2, the instant messaging identification of User 3, the instant messaging identification of User 4, the instant messaging identification of User 5, the instant messaging identification of User 6, the instant messaging identification of User 7, and the instant messaging identification of User 8.

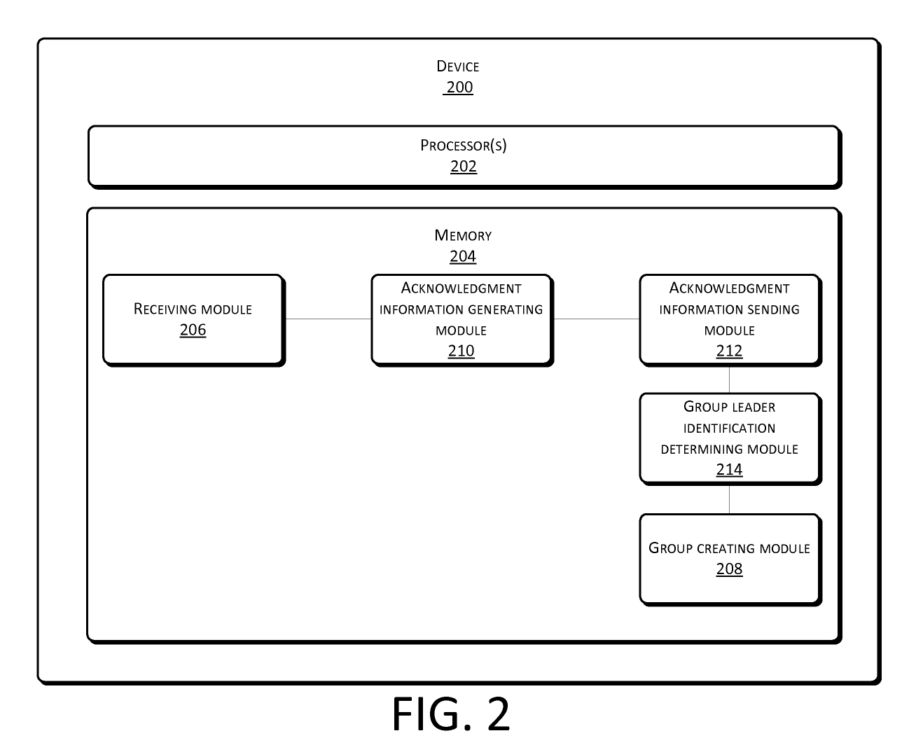

A third example embodiment of the present disclosure is described below. FIG. 2 illustrates a diagram of an example device 200 for creating a user group according to the third embodiment of the present disclosure.

The device 200 may include one or more processor(s) or data processing unit(s) 202 and memory 204. The device 200 may further include one or more input/output apparatuses and network interfaces (not shown in FIG. 2). The memory 204 is an example of computer-readable media.

The computer-readable media includes permanent and non-permanent, movable and non-movable media that may use any methods or techniques to implement information storage. The information may be computer-readable instructions, data structure, software modules, or any data. The example of computer storage media may include, but is not limited to, phase-change memory (PCM), static random access memory (SRAM), dynamic random access memory (DRAM), other type RAM, ROM, electrically erasable programmable read only memory (EEPROM), flash memory, internal memory, CD-ROM, DVD, optical memory, magnetic tape, magnetic disk, any other magnetic storage device, or any other non-communication media that may store information accessible by the computing device. As defined herein, the computer-readable media does not include transitory media such as a modulated data signal and a carrier wave.

The memory 204 may store therein a plurality of modules or units including a receiving module 206 and a group creating module 208.

The receiving module 206 receives multiple group creation information sent by at least two instant messaging client terminals respectively, wherein each piece of group creation information includes instruction information for creating a user group and a respective instant messaging identification information of a respective user logging into the respective instant messaging client terminal.

The group creating module 208 determines a group creation information set including the same instruction information according to the instruction information for creating a user group included in the group creation information, creates a user group according to the instant messaging identification included in the group creation information in the group creation information set, determines a group identification of the user group, and establishes a corresponding relationship between the instant messaging identification included in the user group and the group identification of the user group.

For example, the group identification of the user group may be determined according to the instruction information included in the group creation information set. In another example embodiment of the present disclosure, the device 200 may further include an acknowledgment information generating module 210 and an acknowledgment information sending module 212 stored on the memory 204.

The acknowledgment information generating module 210 generates a group creation acknowledgment notification, wherein the group creation acknowledgment notification carries the instant messaging identification included in the group creation information in the group creation information set.

The acknowledgment information sending module 212 carries, in the group creation acknowledgment information, the instant messaging identification information of other users besides the group leader, and sends it to the instant messaging client terminal corresponding to the instant messaging identification of the group leader. The instant messaging identification informations of other users are included in each piece of group creation information in the group creation information set.

The device 200 may further include a group leader identification determining module 214 stored on the memory 204.

The group leader identification determining module 214 selects an instant messaging identification included in a piece of group creation information from the group creation information set as a group leader instant messaging identification of the to-be-created user group corresponding to the group creation information set.

For example, the group creating module 208 receives group creation feedback information sent by the instant messaging client terminal corresponding to the group leader instant messaging identification, wherein the group creation feedback information includes the instant messaging identifications of other users allowed to join the same group as determined by the group leader user corresponding to the group leader instant messaging identification.

The group creating module 208 establishes a corresponding relationship between the instant messaging identifications of other users included in the group creation feedback information and the group identification of the user group according to the instant messaging identifications of other users included in the group creation feedback information.

The group creation information sent by the group creation initiator through the instant messaging client terminal includes group leader information.

The group leader identification determining module 214 determines whether the group creation information in the group creation information set includes the group leader information; and if a piece of group creation information in the group creation information set includes the group leader information, uses the instant messaging identification included in the group creation information as the group leader instant messaging identification of the to-be-created user group corresponding to the group creation information set.

For example, the group creation information or instruction information received from the respective client terminal may include or be associated with the respective location information of the respective user.

The group creating module 208 determines whether a difference between the location information included in each piece of group creation information and a set location information threshold is less than a set threshold and uses the multiple pieces of group creation information with a determining result that the difference between the location information included in the group creation information and the set location information threshold is less than the set threshold as the group creation information set including the same instruction information.

For example, the group creation information sent by the group creation initiator through the instant messaging client terminal may include or be associated with an effective time for sending the group creation information.

The group creating module 208 determines whether the time for each piece of group creation information in the group creation information set conforms to the effective time for sending the group creation information included in the group creation information sent by the group leader, and, with respect to the group creation information with the determining result as conforming in the group creation information set, creates the user group, wherein the user group includes the instant messaging identification of the user included in the group creation information with the determining result as conforming.

The device and the instant messaging client terminals as described in the example embodiments of the present disclosure may be implemented through either hardware or software, which is not limited herein, and may be either applied on a terminal device or a client terminal device, which is not limited herein. For example, the instant messaging client terminal may include one or more processor(s) or data processing unit(s), one or more input/output devices and network interfaces. The instant messaging client terminal may be a mobile terminal installed with messaging programs to have messaging functionality. The instant messaging client terminal may also include a location apparatus such as compass or a GPS-receiver for providing location or position information of the instant messaging client terminal.

Those skilled in the art should understand that, the embodiments of the present disclosure may be implemented as a method, an apparatus (device), or a computer program product. Therefore, the present disclosure may be implemented as a completely hardware embodiment, a completely software embodiment, or an embodiment combining software and hardware. Moreover, the present disclosure may be in the form of a computer program product implemented on one or more computer-readable media (including, but not limited to, a magnetic disk memory, a CD-ROM, an optical memory, and the like) including compute-executable instructions.

The present disclosure is described with reference to flow charts and/or block diagrams of the method, apparatus (device) and computer program product according to the example embodiments of the present disclosure. It will be understood that each process and/or block of the flowchart illustrations and/or block diagrams, and combinations of processes and/or blocks in the flowchart illustrations and/or block diagrams, may be implemented by computer-executable instructions. These computer-executable instructions may be provided to a processor of a general purpose computer, special purpose computer, embedded processor or other programmable data processing device to produce a machine, such that the instructions, which are executed via the processor of the computer or other programmable data processing device, create the apparatus for implementing the functions specified in the one or more processes of the flowchart and/or one or more blocks of the block diagram.

These computer-executable instructions may also be stored in computer-readable media that direct a computer or other programmable data processing device to function in a particular mode, such that the instructions stored in the computer-readable media produce an article of manufacture including an instruction apparatus which implements the function specified in the one or more processes of the flowchart and/or one or more blocks of the block diagram.

These computer-executable instructions may also be loaded onto a computer or other programmable data processing device to cause a series of operational steps to be performed on the computer or other programmable device to produce a computer-implemented process such that the instructions which execute on the computer or other programmable device provide steps for implementing the functions specified in the one or more processes of the flowchart and/or one or more blocks of the block diagram.

Although the example embodiments of the present disclosure have been described, once having learnt the basic inventive concept, those skilled in the art may make additional change and modification on these embodiments. Therefore, the appended claims are intended to interpret the example embodiments and all other changes and modifications which fall into the scope of the present disclosure.

It is apparent that those skilled in the art may make various modifications and alternations to the present disclosure without departing from the spirit and scope of the present disclosure. Thus, if such modifications and alterations to the present disclosure belong to the scope of the claims and the equivalent technologies thereof, the present disclosure is intended to contain such modifications and alterations.

What is claimed is:

1. A method comprising:
receiving group creation information sent by at least two instant messaging client terminals respectively, a respective piece of group creation information including instruction information for creating a user group and a respective instant messaging identification of a respective user of a respective instant messaging client terminal;
determining a group creation information set according to the instruction information included in the respective piece of group creation information, the group creation information set including the group creation information with the instruction information; and
creating the user group according to the respective instant messaging identification included in the respective group creation information of the group creation information set.

2. The method of claim 1, further comprising:
determining a group identification of the user group; and
establishing a corresponding relationship between the respective instant messaging identification and the group identification.

3. The method of claim 2, wherein the determining the group identification comprises determining the group identification according to the instruction information.

4. The method of claim 1, further comprising:
generating a group creation acknowledgment notification that carries the respective instant messaging identification; and
sending the group creation acknowledgment notification to the respective instant messaging client terminal.

5. The method of claim 1, further comprising:
selecting a particular instant messaging identification included in a particular piece of group creation information from the group creation information set as a group leader instant messaging identification of the user group.

6. The method of claim 5, wherein the creating the user group comprises:
receiving group creation feedback information sent by a particular instant messaging client terminal corresponding to the group leader instant messaging identification, the group creation feedback information including instant messaging identifications of other users allowed to join the same group as determined by a group leader user corresponding to the group leader instant messaging identification; and
establishing a corresponding relationship between the instant messaging identifications of the other users included in the group creation feedback information and a group identification of the user group.

7. The method of claim 5, wherein the particular piece of group creation information sent by a group creation initiator through a particular instant messaging client terminal includes group leader information.

8. The method of claim 1, further comprising:
determining whether the respective piece of group creation information includes group leader information; and
using the respective instant messaging identification included in the respective piece of group creation information as a group leader instant messaging identification of the user group, in response to determining that the respective piece of group creation information includes the group leader information.

9. The method of claim 1, wherein the instruction information includes static information including a character string or a two-dimensional code.

10. The method of claim 1, wherein:
the respective piece of group creation information is associated with respective location information of the respective user; and
the determining the group creation information set comprises:
determining whether a difference between the respective location information of the respective user and a set location information threshold is less than a set threshold; and
including the respective piece of group creation information in the group creation information set, in response to determining that the difference between the respective location information and the set location information threshold is less than the set threshold.

11. The method of claim 1, wherein:
the respective piece of group creation information is associated with respective time; and
the determining the group creation information set comprises:
determining whether the respective time for the respective piece of group creation information conforms to an effective time for sending the group creation information included in a particular group creation information sent by a group leader; and
including the respective piece of group creation information in the group creation information set, in response to determining that the respective time for the respective piece of group creation information conforms to the effective time.

12. A device comprising:
a receiving module that receives group creation information sent by at least two instant messaging client terminals respectively, a respective piece of group creation information including instruction information for creating a user group and a respective instant messaging identification of a respective user of a respective instant messaging client terminal; and
a group creating module that determines a group creation information set according to the instruction information included in the respective piece of group creation information, the group creation information set including the group creation information with the instruction information, and creates the user group according to the respective instant messaging identification included in the respective group creation information of the group creation information set.

13. The device of claim 12, wherein a group identification of the user group is determined according to the instruction information.

14. The device of claim 12, further comprising:
an acknowledgment information generating module that generates a group creation acknowledgment notification that carries the respective instant messaging identification; and
an acknowledgment information sending module that sends the group creation acknowledgment notification to the respective instant messaging client terminal.

15. The device of claim 12, further comprising:
a group leader identification determining module that selects a particular instant messaging identification included in a particular piece of group creation information from the group creation information set as a group leader instant messaging identification of the user group,
wherein:
the group creating module further receives group creation feedback information sent by a particular instant messaging client terminal corresponding to the group leader instant messaging identification, the group creation feedback information including the instant messaging identifications of other users allowed to join the user group as determined by a group leader user corresponding to the group leader instant messaging identification, and establishes a corresponding relationship between the instant messaging identifications of the other users included in the group creation feedback information and a group identification of the user group.

16. The device for creating of claim 15, wherein:
the group leader identification determining module determines whether the respective piece of group creation information includes group leader information, and uses the respective instant messaging identification included in the respective piece of group creation information as the group leader instant messaging identification of the user group, in response to determining that the respective piece of group creation information includes the group leader information.

17. The device of claim 12, wherein the instruction information includes static information including a character string or a two-dimensional code.

18. The device of claim 12, wherein:
the respective piece of group creation information is associated with respective location information of the respective user; and
the group creating module further determines whether a difference between the respective location information of the respective user and a set location information threshold is less than a set threshold, and includes the respective piece of group creation information in the group creation information set, in response to determining that the difference between the respective location information and the set location information threshold is less than the set threshold.

19. The device of claim 12, wherein:
the respective piece of group creation information is associated with respective time; and
the group creating module further determines whether the respective time for the respective piece of group creation information conforms to an effective time for sending the group creation information included in a particular group creation information sent by a group leader, and includes the respective piece of group creation information in the group creation information set, in response to determining that the respective time for the respective piece of group creation information conforms to the effective time.

20. One or more memories having stored thereon computer-executable instructions executable by one or more processors to perform operations comprising:
receiving group creation information sent by at least two instant messaging client terminals respectively, a respective piece of group creation information including instruction information for creating a user group and a respective instant messaging identification of a respective user of a respective instant messaging client terminal;
determining a group creation information set according to the instruction information included in the respective piece of group creation information, the group creation information set including the group creation information with the instruction information; and
creating the user group according to the respective instant messaging identification included in the respective group creation information of the group creation information set.
